(19) United States
(12) Patent Application Publication
(10) Pub. No.: US 2010/0085391 A1
(43) Pub. Date: Apr. 8, 2010

(54) APPARATUS AND METHOD FOR CONTROLLING LED OPERATION IN PORTABLE APPARATUS

(75) Inventor: Jin-Soo HA, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/573,351

(22) Filed: Oct. 5, 2009

(30) Foreign Application Priority Data
Oct. 7, 2008 (KR) 2008-97977

(51) Int. Cl. G09G 5/10

(52) U.S. Cl. 345/690; 345/102

(57) ABSTRACT

An LED driving apparatus and a method thereof in a portable terminal controls an input time difference between a signal controlling LED driving and a signal controlling LED brightness input to an LED driver. The input time differences are controlled in order to prevent an abnormal LED operation generated due to the input time difference between the signal controlling the LED driving and the signal controlling the LED brightness in a portable terminal. The LED driving apparatus includes a controller. When detecting the signal controlling the LED brightness prior to the signal controlling the LED driving, the controller controls an input time of the signal controlling the LED driving provided to the LED driver.

### CLAIM OF PRIORITY

This application claims the benefit under 35 U.S.C. §119(a) from a Korean patent application filed in the Korean Intellectual Property Office on “Oct. 7, 2008” and assigned Serial No. 10-2008-0097977, the entire disclosure of which is hereby incorporated by reference in its entirety.

### BACKGROUND OF THE INVENTION

1. Field of the Invention

The present invention relates generally to a Light Emitting Diode (LED) driving apparatus and a method thereof in a portable terminal. More particularly, the present invention relates to an LED driving apparatus and a method thereof for to prevent abnormal LED driving generations.

2. Description of the Related Art

A portable apparatus for communication is quickly becoming indispensable to people in modern terms and can be used without regard to age or sex, and service providers as well as terminal manufacturers competitively develop a product (or service) for differentiation from other companies.

For example, a plurality of portable apparatuses, such as mobile communication terminals, have developed into a multimedia apparatuses, that in addition to voice communication can also support a phone book, a game, a short message, and electronic (e)-mail, a morning call, an MPEG layer 3 (MP3), a digital camera, and a wireless Internet service to provide various services.

The portable apparatus which provides the above-mentioned services typically includes a separate display window for outputting visual information of a relevant service to a user.

Accordingly, a manufacturer of portable apparatuses manufacturers a display window such that the display window emits light to allow the user to see the display, even in a dark ambient environments.

Emitting light from the display window of the portable apparatus not only allows a user to be able to read the display in a dark place, but also develops as a peculiar service representing personality of a user of the portable apparatus.

In order to allow light of the display window to be emitted a control signal is used that controls the amount of light for the display window to emit, and thereby the control signal also controls the brightness of the lights.

A signal controlling the brightness of light should be input prior to control the portable apparatus to perform a normal light emitting operation a signal controlling a light emitting operation.

In the case in which a signal controlling the brightness of light is input after a signal to begin a light emitting operation in the portable apparatus, there is a problem in that the portable apparatus cannot process the operation of the display window such that the display window emits light as desired.

Therefore, to resolve the above-described problem, there is a need for an apparatus and method in which a light emitting apparatus prevents the problem of an abnormal display window in a portable apparatus.

### SUMMARY OF THE INVENTION

An exemplary aspect of the present invention is to provide an apparatus and a method for preventing an abnormal LED operation generated due to an input time difference between a signal controlling LED driving and a signal controlling LED brightness in a portable apparatus.

Another exemplary aspect of the present invention is to provide an apparatus and a method for controlling a time difference between a signal controlling LED driving and a signal controlling LED brightness input to an LED driver in order to prevent an abnormal LED operation in a portable apparatus.

Still another exemplary aspect of the present invention is to provide an apparatus and a method for, when detecting a signal controlling LED driving first, standing by until a signal controlling LED brightness is detected, and then providing the two signals to an LED driver simultaneously.

In accordance with an exemplary aspect of the present invention, a portable apparatus for preventing an abnormal Light Emitting Diode (LED) operation is provided. The apparatus typically includes: a controller for, when detecting a signal controlling LED driving, determining whether the signal controlling the LED driving is detected prior to a signal controlling LED brightness, and when the signal controlling the LED driving is detected prior to the signal controlling the LED brightness, for controlling an input time of the signal controlling the LED driving provided to an LED driver.

In accordance with another aspect exemplary of the present invention, a method for preventing an abnormal LED operation in a portable apparatus is provided includes: when detecting a signal controlling LED driving, determining whether the signal controlling the LED driving is detected prior to a signal controlling LED brightness; and when detecting the signal controlling the LED driving prior to the signal controlling the LED brightness, controlling an input time of the signal controlling the LED driving provided to an LED driver.

Other exemplary aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary aspects, features and advantages of certain exemplary embodiments of the present invention will become more apparent from the following description taken in conjunction with the accompanying drawings in which:

FIG. 1 is a block diagram illustrating a portable apparatus for preventing an LED operation error according to an exemplary embodiment of the present invention;

FIG. 2 is a flowchart illustrating an LED driving procedure of a portable apparatus according to an exemplary embodiment of the present invention; and

FIG. 3 illustrates an LED driving procedure of a portable apparatus according to an exemplary embodiment of the present invention.

### DETAILED DESCRIPTION

The following description, with reference to the accompanying drawings, is provided to assist in a comprehensive understanding of exemplary embodiments of the invention as defined by the appended claims. The description includes various specific details to assist a person of ordinary skill the art with understanding the claimed invention, but these are to be regarded as merely exemplary. Accordingly, those of ordinary skill in the art will recognize that various changes and modifications of the illustrative examples described herein can be made without departing from the spirit of the invention and the scope of the appended claims. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural references unless the context clearly dictates otherwise. Thus, for example, a reference to “a component surface” includes reference to one or more of such surfaces.

By the term “substantially” it is typically meant that the recited characteristic, parameter, or value need not be achieved exactly, but that deviations or variations, including but in no way limited to, for example, tolerances, measurement error, measurement accuracy limitations and other factors known to persons of ordinary skill in the art, may occur in amounts that do not preclude the effect the characteristic was intended to provide.

Exemplary embodiments of the present invention will now be described herein below with reference to the accompanying drawings. In the following descriptions, well-known functions or constructions may not be described in detail when their inclusion would obscure appreciation of the invention by a person of ordinary skill in the art with unnecessary detail about the well-known functions or constructions.

Exemplary embodiments of the present invention provide an LED driving apparatus and a method thereof, for controlling an input time difference between a signal controlling an LED driving and a signal controlling LED brightness input to an LED driver in order to prevent an abnormal LED driving generated due to the input time difference between the signal controlling the LED driving and the signal controlling the LED brightness in a portable apparatus.

Also, just a few of the non-limiting examples of the portable apparatus according to the present invention may include, for example, a cellular phone, a Personal Communication System (PCS), a Personal Digital Assistant (PDA), an International Mobile Telecommunication-2000 (IMT-2000) terminal, a Personal Computer (PC), and a notebook computer. The following description will now be made using a general construction of the above examples.

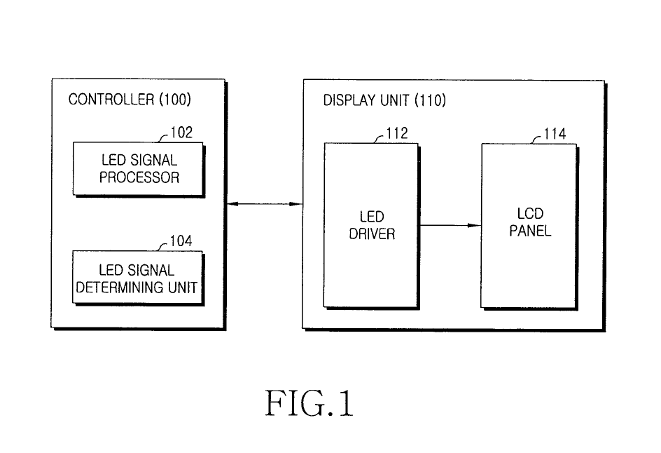

FIG. 1 is a block diagram illustrating a portable apparatus for preventing an LED operation error according to an exemplary embodiment of the present invention.

Referring now to the example shown FIG. 1, an exemplary portable apparatus according to the present invention may include, for example, a controller 100 and a display unit 110. Also, though the portable apparatus may include a plurality of units such as an input unit and a memory unit, detailed descriptions of other parts except the controller 100 and the display unit 110 are omitted in exemplary embodiments of the present invention.

First, the construction of the controller 100 of the portable apparatus will now be described, and may include an LED signal processor 102 and an LED signal determining unit 104.

The controller 100 of the portable apparatus controls an overall operation of the portable apparatus. For example, in the case where the portable apparatus is a mobile communication terminal, the controller 100 performs a process and a control for voice communication and data communication, and controls the brightness of the display unit 110 of the portable apparatus by controlling LED light emission. The controller 100 includes an LED signal processor 102 and an LED signal determining unit 104. The display unit 110 includes an LEF driver and an LCD panel.

Furthermore, the controller 100 provides a signal for controlling an LED of the display unit 110 to the display unit 110 according to an exemplary embodiment of the present invention. In other words, the controller 100 controls a LED signal determining unit 104 to detect a signal controlling an LED driving and a signal controlling LED brightness.

When receiving information indicating a signal controlling the LED driving is detected before a signal controlling the LED brightness is detected from the LED signal determining unit 104, the controller 100 controls the LED signal processor 102 to wait until a signal controlling the LED brightness has been detected, and then the controller 100 transfers the signal controlling the LED brightness to an LED driver 112 of the display unit 110 first, or transfers the signal controlling the LED brightness and the signal controlling the LED driving to the LED driver 112 simultaneously.

Still referring to FIG. 1, the signal controlling the LED driving denotes an EN signal which is a signal operating an LED backlight unit, and the signal controlling the LED brightness denotes a Pulse Width Modulation (PWM) signal which is a control signal for decreasing or increasing the brightness of the LED backlight unit.

When detecting a signal controlling the LED driving before detecting a signal controlling the LED brightness, the LED processor 102 receives an instruction from the controller 100 to wait until a signal controlling the LED brightness has been detected, and then transfers the signal controlling the LED brightness to the LED driver 112 first, or transfers the signal controlling the LED brightness and the signal controlling the LED driving to the LED driver 112 simultaneously.

The LED signal determining unit 104 detects a signal controlling the LED driving of the display unit 110, and a signal controlling the LED brightness of the display unit 110, and transfers a point at which each signal is detected to the controller 100.

The display unit 110 may include the LED driver 112 and a Liquid Crystal Display (LCD) panel 114. The display unit 110 displays state information, a limited number of letters, and a large amount of moving images and still images during the operation of the portable apparatus. For the display unit 110, a color LCD may be used.

The LED driver 112 controls the LCD panel 114 using a signal controlling the LED driving and a signal controlling the LED brightness transferred from the LED signal processor 102 of the controller 100. The LCD panel 114 operates the display unit 110 or controls the brightness of the display unit 110 under control of the LED driver 112.

The functions of the LED signal processor 102 and the LED signal determining unit 104 may be performed by the controller 100 of the portable apparatus. The separate configuration and illustration of the LED signal processor 102 and the LED signal determining unit 104 are an exemplary purpose only for inconvenience in description, not for limiting the scope of the present invention. It would be obvious to those skilled in the art that various modifications may be made within the scope of the present invention. For example, all of the functions of the LED signal processor 102 and the LED signal determining unit 104 may processed by the controller 100.

In the above, description has been made to an LED driving apparatus for controlling an input time difference between a signal controlling LED driving and a signal controlling LED brightness input to an LED driver in order to prevent an abnormal LED operation generated due to the input time difference between the signal controlling the LED driving and the signal controlling the LED brightness in a portable apparatus. Now, description will be made for a method for preventing an abnormal LED operation by controlling a time difference between a signal controlling LED driving and a signal controlling LED brightness input to the LED driver using the apparatus according to an exemplary embodiment of the present invention.

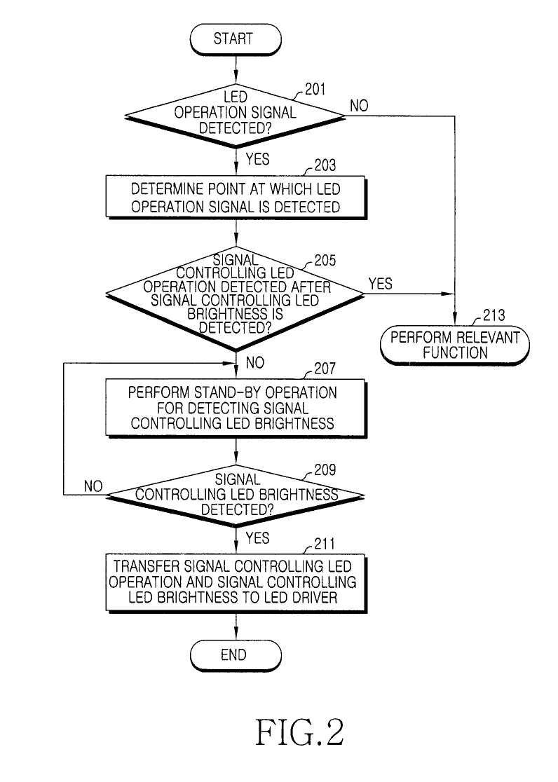

FIG. 2 is a flowchart illustrating exemplary operation of an LED driving procedure of a portable apparatus according to an exemplary embodiment of the present invention. Referring now to FIG. 2, in step 201, the portable apparatus determines whether an LED driving signal is detected.

When the LED driving signal is not detected in step 201, the portable apparatus performs a relevant function (for example, stand-by mode) in step 213.

When the LED driving signal is detected in step 201, the portable apparatus determines a point at which the LED driving signal has been detected in step 203. This step is for determining whether a signal controlling LED driving is input prior to a signal controlling LED brightness and so LED operation is impossible. When determining that a signal controlling the LED brightness and a signal controlling the LED driving are input simultaneously, or the signal controlling the LED brightness is input before the signal controlling the LED driving, the portable apparatus may determine a normal operation of the LED is possible.

Accordingly, when detecting a signal controlling the LED driving after detecting a signal controlling the LED brightness, the portable apparatus determines a normal LED operation is possible in step 205, and performs a relevant function (for example, general LED control function) in step 213.

In contrast, when detecting the signal controlling the LED driving prior to a signal controlling the LED brightness, the portable apparatus determines the signal controlling the LED driving is input first and so a normal LED operation is impossible in step 205. Accordingly, the portable apparatus performs a stand-by operation for detecting a signal controlling the LED brightness in step 207.

Here, at step 207, which is a stand-by operation for detecting a signal controlling the LED brightness, this step is different from an operation of a general LED control method, and prevents the portable apparatus from transferring an LED driving signal to the LED driver first.

In other words, when a signal controlling the LED driving is input first, unlike the conventional art which directly provides the signal to the LED driver, the portable apparatus according to an exemplary embodiment of the present invention waits until a signal controlling the LED brightness is detected for a normal LED operation, and transfers the signal controlling the LED brightness first to the LED driver, or transfers the signal controlling the LED brightness and the signal controlling the LED driving to the LED driver simultaneously, thereby preventing an LED malfunction caused by the signal controlling the LED driving arriving first.

Next, at step 209, the portable apparatus determines whether the signal controlling the LED brightness is detected in step 209.

When not detecting the signal controlling the LED brightness in step 209, the portable apparatus performs step 207 again.

In contrast, when the signal controlling the LED brightness is detected in step 209, the portable apparatus transmits the signal controlling the LED driving and the signal controlling the LED brightness to the LED driver in step 211. At this point, as described above, the portable apparatus may prevent an LED malfunction caused by the signal controlling the LED driving by transferring the signal controlling the LED brightness to the LED driver first, or transferring the signal controlling the LED brightness and the signal controlling the LED driving to the LED driver simultaneously.

After that, the portable apparatus ends the present algorithm.

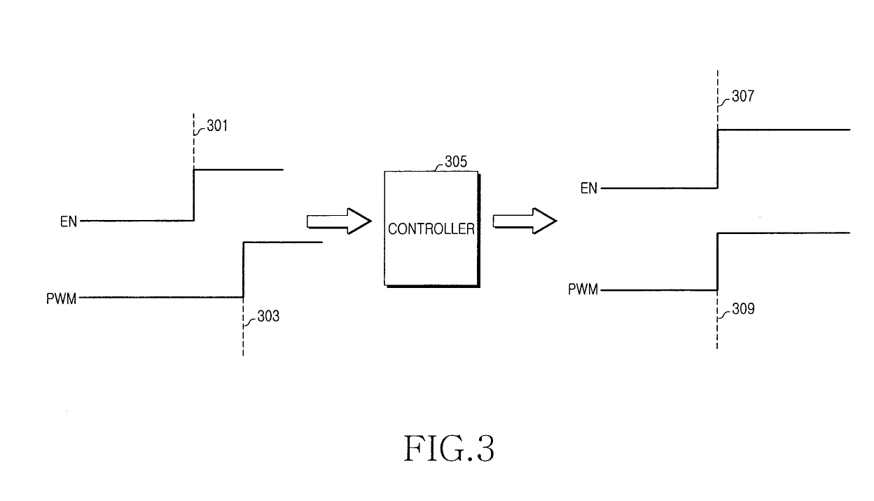

FIG. 3 illustrates signal flow for an LED driving procedure of a portable apparatus according to another exemplary embodiment of the present invention.

Referring to FIG. 3, for an LED operation, a controller of the portable apparatus detects a signal controlling LED driving and a signal controlling LED brightness.

Here, the signal controlling the LED driving denotes an EN signal (triggered at 301) which is a signal operating an LED backlight unit, and the signal controlling the LED brightness denotes a PWM signal (triggered at 303) which is a control signal for decreasing or increasing the brightness of the LED backlight unit. A person of ordinary skill in the art understands and appreciates that the present invention is broader than the example provided regarding the aforementioned EN signal and PWM signal.

At this point, the detection of the signals by the controller of the portable apparatus may be classified into three possible cases below:

1. The controller detects the signal controlling the LED driving and the signal controlling the LED brightness simultaneously; or

2. The controller detects the signal controlling the LED driving after detecting the signal controlling the LED brightness; or

3. The controller detects the signal controlling the LED brightness after detecting the signal controlling the LED driving.

In cases 1 and 2, even the conventional portable apparatus may perform a normal LED operation. In case 3, the conventional portable apparatus cannot control the LED operation normally.

Therefore, the portable apparatus according to an exemplary embodiment of the present invention performs the following operations in order to prevent an abnormal LED operation generated in case 3.

As in case 3, and referring again to FIG. 3, when the controller 305 of the portable apparatus detects the signal 303 controlling the LED brightness after detecting the signal 301 controlling the LED driving, that is, when the controller 305 detects the signal controlling the LED driving before detecting signal controlling the LED brightness, the controller 305 does not transfer the detected signal controlling the LED driving to an LED driver but stands by until the signal controlling the LED brightness is detected.

Subsequent to be in standby until the signal controlling LED brightness is detected, after detecting the signal controlling the LED brightness, the controller 305 transfers the detected signal 307 controlling the LED driving and the detected signal 309 controlling the LED brightness to the LED driver, simultaneously. At this point, as in case 2, the controller 305 may prevent an abnormal LED operation generated to a conventional portable apparatus by transferring the signal controlling the LED brightness first to the LED driver, and then transferring the signal controlling the LED driving to the LED driver.

Accordingly, the LED driver may allow a normal LED operation by receiving the signal 307 controlling the LED driving and the signal 309 controlling the LED brightness simultaneously, or receiving the signal 309 controlling the LED brightness first.

As described in the above-mentioned exemplary embodiments of the present invention, an abnormal LED driving problem generated when a signal controlling LED driving is input prior to a signal controlling LED brightness in a conventional portable apparatus is solved by controlling an input time difference between the signal controlling the LED driving and the signal controlling the LED brightness input to an LED driver in order to prevent an abnormal LED operation generated due to the input time difference between the signal controlling the LED driving and the signal controlling the LED brightness in a portable apparatus.

Although the invention has been shown and described with reference to certain exemplary embodiments thereof, it will be understood by those skilled in the art that various changes in form and details may be made therein without departing from the spirit and scope of the invention as defined by the appended claims and their equivalents. For example, while the signal driving the LED may be transmitted after the signal controlling the brightness, it is within the spirit and scope of the invention that there can be an overlap between the signals of a predetermined period. Therefore, the scope of the present invention is not limited to the above-described embodiments but should be determined by not only the appended claims but also the equivalents thereof.

What is claimed is:

1. A portable apparatus for preventing an abnormal Light Emitting Diode (LED) operation, the apparatus comprising:
an LED driver for a display unit;
a controller in communication with the LED driver for detecting a first signal for controlling LED brightness and a second signal for controlling LED driving;
wherein when said controller detects that the second signal precedes detecting the first signal, said controller controlling an input time of the second signal provided to the LED driver.

2. The apparatus of claim 1, wherein said controller further comprises:
an LED signal determining unit for detecting the second signal and the first signal; and
an LED signal processor for, when detecting the second signal prior to the first signal, controlling an input time of the second signal by delaying provision of the second signal to the LED driver until the first signal is detected.

3. The apparatus according to claim 2, wherein the delaying by the controller comprises standing until the first signal is detected.

4. The apparatus of claim 2, wherein the LED signal processor controls the input time of the second signal by transmitting the detected first and second signals to the LED driver simultaneously.

5. The apparatus of claim 2, wherein the LED signal processor controls the input time of the second signal by transmitting the second signal to the LED driver after transmitting the first signal to the LED driver.

6. The apparatus of claim 1, further comprising a display unit including at least one LED coupled to the LED driver, wherein the LED driver drives said at least one LED for background brightness of the display unit.

7. The apparatus of claim 6, wherein the display unit comprises an LCD panel.

8. A method for preventing an abnormal Light Emitting Diode (LED) operation in a portable apparatus, the method comprising:
detecting when a first signal for controlling brightness of LED and a second signal for controlling driving an LED driver are received;
determining an order in which said first signal and said second signal are received;
when said second signal is received prior to receiving the first signal, controlling an input time of the second signal provided to an LED driver.

9. The method according to claim 8, wherein a controller detects receipt of the first signal and the second signal.

10. The method according to claim 9, wherein the controller is coupled with an LED signal processor, wherein the LED signal processor receives an instruction from the controller to wait until the first signal for controlling LED brightness has been received.

11. The method according to claim 10, wherein an LED signal determining unit detects receiving the first and second signals.

12. The method of claim 9, wherein the controlling of the input time of the second signal comprises:
determining whether the second signal has been detected prior to detecting receiving the first signal; and
when detecting the second signal prior to the first signal, standing by until the first signal is detected.

13. The method of claim 12, wherein the controlling of the input time of the second signal comprises:
when detecting the first signal, providing the first signal and the second signal to an LED driver, simultaneously.

14. The method of claim 12, wherein the controlling of the input time of the second signal comprises:
when detecting the first signal, transmitting the second signal to the LED driver after transmitting the first signal to the LED driver.

15. The method according to claim 14, wherein the transmitting of the second signal begins after transmitting the first signal and overlaps the first signal by a predetermined time.

16. The method according to claim 9, wherein the first and second signals detected are provided to a display unit of the portable apparatus being coupled to the LED driver.

17. The method according to claim 9, wherein the display unit includes an LCD panel and the LED brightness being controlled is providing background light for the LCD panel of the portable apparatus.
